(19) United States
(12) Patent Application Publication
(10) Pub. No.: US 2008/0216482 A1
(43) Pub. Date: Sep. 11, 2008

(54) BURNER LANCE

(75) Inventors: Stefano Bernero, Oberrohrdorf (CH); Thomas Ruck, Rekingen (CH); Christian Steinbach, Birmenstorf (CH); Martin von Planta, Oetwil an der Limmat (CH)

Correspondence Address: Volpe and Koenig, P.C.;Dept. Alstom, 30 South 17th Street, United Plaza, Suite 1600, Philadelphia, PA, 19103, US

(73) Assignee: ALSTOM TECHNOLOGY LTD., Baden (CH)

(21) Appl. No.: 12/115,129

(22) Filed: May 5, 2008

Related U.S. Application Data
(63) Continuation of application No. PCT/EP2006/067423, filed on Oct. 16, 2006.

(30) Foreign Application Priority Data
Nov. 4, 2005 (CH) 01768/05

(51) Int. Cl. F02C 7/22; F23D 14/02

(52) U.S. Cl. 60/737; 239/398

(57) ABSTRACT

A lance for introducing fuel into a combustion chamber of a burner, in particular of a turbine plant is provided. The lance includes a lance head, a fuel feed, an oxidator feed and a control device. The lance head projects into the combustion chamber and includes a fuel nozzle and an oxidator outlet orifice. The fuel feed extends in the lance and is connected to the fuel nozzle. The oxidator feed extends in the lance head and is connected to the oxidator outlet orifice. The control device controls a flow cross sectional area of the oxidator feed. The control device has a control piston installed in the lance head with stroke adjustability for stroke-dependent controlling of the flow cross sectional area of the oxidator feed.

### CROSS REFERENCE TO RELATED APPLICATIONS

This application is a continuation of International Application No. PCT/EP2006/067423 filed Oct. 16, 2006, which claims priority to Swiss Patent Application No. 01768/05, filed Nov. 4, 2005, the contents of which are incorporated by reference as if fully set forth.

### FIELD OF INVENTION

The invention relates to a lance for introducing a fuel into a mixing path of a premix burner, especially a premix burner of a gas turbine plant.

### BACKGROUND

DE 100 50 248 A1 discloses such a lance, which has a lance head, a fuel feed, an oxidator feed, and a control device. The lance head, in the installed state, projects into the mixing path of the burner, and has at least one fuel nozzle for injection of fuel into the mixing path, and also at least one oxidator outlet orifice for introducing an oxidator into the mixing path. The fuel feed extends inside the lance and is connected to the at least one fuel nozzle. The oxidator feed extends inside the lance head and is connected to the at least one oxidator outlet orifice. The control device serves for controlling a flow cross sectional area of the oxidator feed. In the disclosed lance, only a single fuel nozzle is provided, being installed centrally in the lance head, from which the fuel flows axially into the mixing path, on the end face of the lance head. Furthermore, only a single oxidator outlet orifice, which is designed in annular form and which coaxially encloses the fuel nozzle, is provided in the disclosed lance. In operation, the oxidator flow flows axially from the oxidator outlet orifice, then flows around a central section of the lance head which has the fuel nozzle, and in the mixing path envelops the injected fuel. In the disclosed lance, the control device has a rotary sleeve valve which includes a plurality of radial control ports. The rotary sleeve valve is rotatably mounted on the outside on a casing of the lance head. The aforesaid casing encloses therein an annular cavity which on the outlet side forms the annular oxidator outlet orifice. A plurality of radial oxidator inlet ports are provided in the casing. By rotation of the rotary sleeve valve, the oxidator inlet ports of the casing can be overlapped by the control ports of the rotary sleeve valve by a greater or lesser degree, by which the flow cross sectional area of the oxidator feed can be controlled.

The cost for realizing controlling of the quantity of oxidator which is fed through the lance head is comparatively large in the disclosed lance.

### SUMMARY

The invention should provide a remedy in this case. The invention, as it is characterized in the claims, deals with the problem of specifying an improved, alternative embodiment for a lance of the type mentioned at the beginning, which is characterized by a comparatively low cost construction or by a simplified realizability, as the case may be.

According to the invention, this problem is solved by the subject of the independent claim. Advantageous embodiments are the subject of the dependent claims.

The invention is based on the general ideas of realizing controlling of the quantity of oxidator which is feedable through the lance by means of a control piston, which for this is installed in the lance head with stroke adjustability. The flow cross sectional area, therefore, can be controlled for opening and closing in dependence upon the stroke of the control piston. Such a stroke movement of the control piston can be realized comparatively simply. The manufacturing cost of the lance is reduced as a result.

For example, the control piston, according to a preferred embodiment type, can be connected axially to a piston rod which extends inside the lance and which especially is connected to a control piston drive on a lance end which is remote from the lance head. In this constructional form, the control piston drive can be installed a relatively long way from the hot burner, as a result of which the cost for cooling of the control piston drive is reduced.

In an advantageous embodiment, the oxidator feed can have a control chamber located in the lance head, which is located upstream of the at least one oxidator outlet orifice and which has at least one radial oxidator inlet port. Preferably then, the control piston is installed in this control chamber with stroke adjustability in such a way that, in dependence upon the stroke, it closes the at least one oxidator inlet port by a greater or lesser degree, so controls it for opening and closing. In this constructional form, the flow-washable cross section of the oxidator feed can be controlled by the axial overlapping between the control piston and the at least one oxidator inlet port. As a result, this construction is characterized by a high reliability.

In another advantageous embodiment, the fuel feed comprises at least one fuel line which extends inside the lance. Therefore, preferably the piston rod and the at least one fuel line are accommodated in the lance.

Further important features and advantages of the lance according to the invention are apparent from the subclaims, from the drawing, and from the associated FIGURE description with reference to the drawing.

### BRIEF DESCRIPTION OF THE DRAWING

A preferred exemplary embodiment of the invention is shown in the drawing and is explained in detail in the subsequent description.

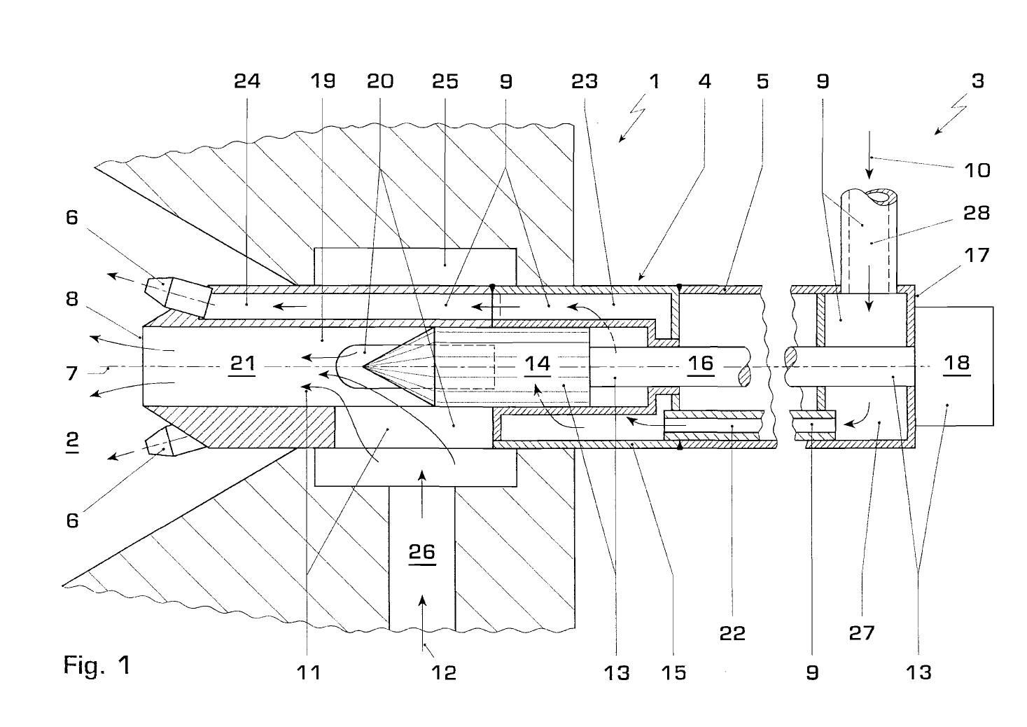

The single FIG. 1 shows a much simplified axial section through a burner in the region of a lance, wherein the lance is shown axially shortened.

### DETAILED DESCRIPTION OF THE PREFERRED EMBODIMENTS

According to FIG. 1, a burner 1 comprises a mixing path 2. The burner 1, which, for example, is a premix burner, can preferably be a component part of a turbine plant, preferably a gas turbine plant. In the head region of the burner 1 which is shown, this is equipped with a lance 3, which has a lance head 4 and a lance shank 5. The lance shank 5 is shown here in its longitudinal direction, so is axially broken up and, therefore, extremely shortened.

The lance head 4, in the installed state which is shown, is installed on the burner 1 so that it projects into the mixing path 2. In this case, a coaxial arrangement of lance 3 and burner 1 is preferred, so that the lance head 4 projects coaxially into the mixing path 2. The lance head 4 has at least one fuel nozzle 6, by means of which fuel can be injected into the mixing path 2. Two such fuel nozzles 6 are exemplarily shown in FIG. 1. Preferably the lance head 4 has four such fuel nozzles 6, which are installed such that they are distributed in the circumferential direction and spaced apart from one another. In principle, however, the number of fuel nozzles 6 is optional. It is noteworthy that the fuel nozzles 6 are installed on the lance head 4 in a radially outer lying edge region. The fuel nozzles 6, therefore, are installed eccentrically with regard to a longitudinal center axis 7 of the lance 3, so are installed with a spacing or on a defined radius, as the case may be.

Furthermore, the lance head 4 is equipped with at least one oxidator outlet orifice 8, by means of which an oxidator can be introduced into the mixing path 2. In the example under consideration, the lance head 4 has only a single oxidator outlet orifice 8. It is noteworthy that the oxidator outlet orifice 8 is located centrally on the lance head 4. The introduction of the oxidator into the mixing path 2, therefore, takes place on the axial end face of the lance head 4 in an axial direction. In addition, therefore, the fuel nozzles 6 are installed so that they are offset radially outwards with regard to the oxidator outlet orifice 8.

It has been shown that the radially outwards offset fuel nozzles 6, especially in burners with larger output, bring about an improved mixing through of the injected fuel with the main oxidator flow which is introduced into the mixing path 2 at another point. As a result of this, a low-emission combustion is promoted. At the same time, the oxidator for the lance head 4, which is fed through the lance head 4, can ensure an adequate cooling and purging. The fuel which is fed through the lance 3 is preferably a liquid fuel, for example diesel oil. A gaseous fuel, such as natural gas, can also be fed. In the case of the oxidator, it is always a matter of a gas containing oxygen, preferably air.

The lance 3, moreover, has a fuel feed 9 which extends in the lance 3 and which, in the installed state, is connected to a fuel supply 10 which is symbolized by an arrow. The fuel feed 9 is connected to the fuel nozzles 6. Furthermore, the lance 3 comprises an oxidator feed 11 which extends inside the lance head 4 and which, in the installed state, is connected to an oxidator supply 12 symbolized by an arrow. The oxidator feed 11 is connected to the oxidator outlet orifice 8.

The lance 3 is still equipped with a control device 13, by means of which a flow cross sectional area of the oxidator feed 11, and therefore the quantity of oxidator which is introducible through the lance head 4 into the mixing path 2, is controllable. The control device 13 comprises a control piston 14 which is installed in the lance head 4 with stroke adjustability. In this case, the control piston 14 is installed inside the oxidator feed 11 so that in dependence upon its stroke it can control the flow cross sectional area of the oxidator feed 11.

In the example which is shown, the control piston 14 is installed, with stroke adjustability, in the longitudinal direction of the lance, therefore parallel to the longitudinal center axis 7. Preferably, the control piston 14 is installed coaxially to the longitudinal center axis 7.

In the preferred embodiment which is shown here, a holding cylinder 15 is also formed in the lance head 4, in which the control piston 14 is mounted with stroke adjustability. Preferably, this holding cylinder 15 is also located coaxially to the longitudinal center axis 7. The control device 13 comprises a piston rod 16 which is axially connected to the control piston 14, in fact connected by its end facing away from the oxidator outlet orifice 8. The piston rod 16 extends inside the lance 3 or inside the lance shank 5 which is designed as a tubular body for this purpose, as the case may be. The embodiment which is shown here is preferred, in which the piston rod 16 extends centrally inside the lance 3 or inside the lance shank 5 which is designed as a tubular body, so extends coaxially to the longitudinal center axis 7. On its lance end 17 remote from the lance head 4, the lance 3 is provided with a control piston drive 18 which in a suitable way is connected to the piston rod 16 with drive effect, and by which the piston rod 16 is axially adjustable. For example, the drive coupling between piston rod 16 and control piston drive 18 is a type of spindle drive.

In the embodiment which is shown here, the control piston 14 is axially pointed on its end facing the oxidator outlet orifice 8. For example, this end is constructed as a cone or a taper.

The oxidator feed 11 comprises a control chamber 19, which is located preferably centrally in the lance head 4. The control piston 14 is installed with stroke adjustability in this control chamber 19. For this, the control chamber 19 is axially connected to the holding cylinder 15, the holding cylinder 15 is axially open towards the control chamber 19 for this purpose. At the same time, the control chamber 19 forms an axial extension of the holding cylinder 15. The control chamber 19 is located upstream of the oxidator outlet orifice 8 and has at least one radial oxidator inlet port 20. Only two such oxidator inlet ports 20 are identifiable in the sectioned view which is shown. Basically, only a single oxidator inlet port 20 may be sufficient. An embodiment is preferred with four oxidator inlet ports 20 which are arranged distributed in the circumferential direction.

Preferably, the oxidator inlet ports 20 are designed as they are here as axial elongated holes, i.e. their axial extent is greater than their extent in the circumferential direction. The axial length of the oxidator inlet ports 20 is matched to the axial stroke which is executable by the control piston 14, so that the control piston 14, by radial overlapping of the oxidator inlet ports 20, can open or close them by a greater or lesser degree in dependence upon its stroke. With the control piston 14 retracted to its maximum into the holding cylinder 15, the oxidator inlet ports 20 are open to their maximum, preferably to 100%. With the control piston 14 extended to its maximum from the holding cylinder 15, the oxidator inlet ports 20 are closed to their maximum, preferably to 100%. With the oxidator inlet ports 20 opened by a greater or lesser degree, the pointed end of the control piston 14 assists a deflection of the oxidator flow of the lowest possible resistance.

The oxidator feed 11, in the embodiment which is shown here, also comprises an oxidator chamber 21 which is connected axially to the control chamber 19, and which forms the oxidator outlet orifice 8 at its end facing away from the control chamber 19. Also, the oxidator chamber 21 is located preferably centrally, so is located in the lance head 4 coaxially to the longitudinal center axis 7.

The fuel feed 9 comprises in this case at least one fuel line 22 which is installed inside the lance 3 or inside the lance shank 5, as the case may be. Only a singe fuel line 22 is shown here. Naturally, more than one fuel line 22 can also be located in the lance 3. It is noteworthy that the fuel line 22 in the example is not formed by the lance 3 or by the lance shank 5 which is designed as a tubular body, as the case may be, but is formed by a separate tubular component which is laid in the lance shank 5. Unlike the piston rod 16, the fuel line 22 in this case extends eccentrically inside the lance shank 5 with regard to the longitudinal center axis 7. In this way, both the piston rod 16 and the fuel line 22 are accommodated in the lance shank 5 which is designed as a tubular body.

The fuel feed 9 in this case also comprises an annular fuel passage 23 which is located in the lance head 4. In this case, the annular fuel passage 23 coaxially encloses the holding cylinder 15. For this, the annular fuel passage 23 is located coaxially in the lance head 4. The annular fuel passage 23 is connected to the fuel line 22. Furthermore, the annular fuel passage 23 is connected to the fuel nozzles 6, and in fact connected by a connecting fuel passage 24 in each case. In this case, these connecting fuel passages 24 extend preferably axially in the lance head 4, therefore parallel to the longitudinal center axis 7. The sectioned view in FIG. 1 covers several planes so as to be able to show in section both one of the oxidator inlet ports 20 and also one of the connecting fuel passages 24.

Preferably, equally as many fuel nozzles 6 and connecting fuel passages 24 are provided as there are oxidator inlet ports 20. The connecting fuel passages 24 and the oxidator inlet ports 20 are located then in the lance head 4, alternating with each other in the circumferential direction.

The oxidator feed 11 is connected by its oxidator inlet ports 20 to an annular cavity 25 which is formed in the burner 1, and is connected to the oxidator supply 12 by at least one feed line 26. The supply of the oxidator takes place, therefore, radially from the outside with regard to the longitudinal center axis 7 of the lance 3. The oxidator flow can be guided radially inwards through the oxidator inlet ports 20, the control chamber 19, and the oxidator chamber 21, and, in fact, so that in the end it flows out centrally in the axial direction from the lance head 4, through the oxidator outlet orifice 8, and flows into the mixing path 2. Unlike this, the fuel is fed axially through the lance 3. As a result of this, the supplied fuel is distributed through the annular fuel passage 23 inside the lance head 4 onto a radius lying radially further out, by means of which it is feedable to the fuel nozzles 6 which are located radially further out with regard to the oxidator outlet orifice 8.

The lance 3, on its lance end 17 remote from the lance head 4, is additionally equipped with a fuel collecting chamber 27 which is connected to the fuel supply 10 by a feed line 28. The at least one fuel line 22 is also connected to this fuel collecting chamber 27.

Preferably, the fuel nozzles 6 are designed so that they inject the fuel into the mixing path 2 obliquely to the axial direction of the lance 3, therefore obliquely to the longitudinal center axis 7. In addition, an embodiment is preferred in which the fuel nozzles 6 inject the fuel into the mixing path 2 obliquely to a central longitudinal plane of the lance 3, which includes the longitudinal center axis 7. By means of this, the fuel is injected in the direction or in the opposite direction, as the case may be, of a swirled flow, which develops in the event of a tangential introduction of the main oxidator flow into the mixing path 2.

### LIST OF DESIGNATIONS

1 Burner
2 Mixing path
3 Lance
4 Lance head
5 Lance shank
6 Burner nozzle
7 Longitudinal center axis
8 Oxidator outlet orifice
9 Fuel feed
10 Fuel supply
11 Oxidator feed
12 Oxidator supply
13 Control device
14 Control piston
15 Holding cylinder
16 Piston rod
17 Lance end
18 Control piston drive
19 Control chamber
20 Oxidator inlet port
21 Oxidator chamber
22 Fuel line
23 Annular fuel passage
24 Connecting fuel passage
25 Annular cavity
26 Feedline
27 Fuel collecting chamber
28 Feedline

1. A lance that introduces fuel into a mixing path (2) of a premix burner (1), in particular a premix burner of a gas turbine plant, the lance comprising:
a lance head (4), which in the installed state, projects into the mixing path (2) of the burner, which has at least one fuel nozzle (6) for the injection of fuel into the mixing path (2) and which has at least one oxidator outlet orifice (8) for introducing an oxidator into the mixing path (2);
a fuel feed (9) extending in the lance (3), which is connected to the at least one fuel nozzle (6);
an oxidator feed (11) extending in the lance head (4), which is connected to the at least one oxidator outlet orifice (8); and
a control device (13) for controlling of a flow cross sectional area of the oxidator feed (11), the control device (13) having a control piston (14) installed in the lance head (4) with stroke adjustability that stroke-dependently controls the flow cross sectional area of the oxidator feed (11).

2. The lance as claimed in claim 1, wherein the control piston (14) is installed with stroke adjustability in the longitudinal direction of the lance.

3. The lance as claimed in claim 1, wherein a holding cylinder (15) is installed in the lance head (4), in which the control piston (14) is installed with stroke adjustability.

4. The lance as claimed in claim 1, wherein the control piston (14) is axially connected to a piston rod (16) which extends inside the lance (3).

5. The lance as claimed in claim 4, wherein the piston rod (16) at a lance end (17) remote from the lance head (4) is connected to a control piston drive (18).

6. The lance as claimed in claim 4, wherein the piston rod (16) extends centrally inside the lance (3).

7. The lance as claimed in claim 4, wherein the lance (3) has a tubular body (5), inside which extends the piston rod (16).

8. The lance as claimed in claim 1, wherein the control piston (14) has an axially pointed end.

9. The lance as claimed in claim 1, wherein the oxidator feed (11) has a control chamber (19) located in the lance head (4), which is located upstream of the at least one oxidator outlet orifice (8) and has at least one radial oxidator inlet port (20).

10. The lance as claimed in claim 9, wherein the control piston (14) is installed in the control chamber (19) with stroke adjustability and, in dependence upon the stroke, closes the at least one oxidator inlet port (20) by a greater or lesser degree.

11. The lance as claimed in claim 9, wherein the at least one oxidator inlet port (20) is designed as an axial elongated hole.

12. The lance as claimed in claim 1, wherein a plurality of oxidator inlet ports (20) are provided, which are installed on the lance head (4), being distributed in a circumferential direction.

13. The lance as claimed in claim 9, wherein the oxidator feed (11) has an oxidator chamber (21) located in the lance head (4), which at one end forms the at least one oxidator outlet orifice (8) and which at the other end is connected to the control chamber (19).

14. The lance as claimed in claim 1, wherein the at least one oxidator outlet orifice (8) is located centrally on the lance head (4).

15. The lance as claimed in claim 1, wherein only a single oxidator outlet orifice (8) is provided.

16. The lance as claimed in claim 3, wherein the holding cylinder (15) is axially adjacent to the control chamber (19) and is axially open towards the control chamber (19).

17. The lance as claimed in claim 1, wherein the fuel feed (9) has at least one fuel line (22) which extends inside the lance (3).

18. The lance as claimed in claim 17, wherein the at least one fuel line (22) extends eccentrically inside the lance (3).

19. The lance as claimed in claim 17, wherein the lance (3) has a tubular body (5), inside which extends the at least one fuel line (22).

20. The lance as claimed in claim 17, wherein the fuel feed (9) has an annular fuel passage (23) which is located in the lance head (4).

21. The lance as claimed in claim 20, wherein the annular fuel passage (23) is connected to the at least one fuel line (22).

22. The lance as claimed in claim 20, wherein the annular fuel passage (23) is connected to the at least one fuel nozzle (6) by at least one connecting fuel passage (24).

23. The lance as claimed in claim 22, wherein the at least one connecting fuel passage (24) extends axially in the lance head (4).

24. The lance as claimed in claim 1, wherein a plurality of fuel nozzles (6) are provided, which are installed on the lance head (4), and are distributed in a circumferential direction.

25. The lance as claimed in claim 22, wherein the respective connecting fuel passage (24) extends in the lance head (4) in a circumferential direction between two oxidator inlet ports (20).

26. The lance as claimed in claim 25, wherein connecting fuel passages (24) and oxidator inlet ports (20) are located in the lance head (4), alternating with each other in the circumferential direction.

27. The lance as claimed in claim 22, wherein the at least one fuel nozzle (6) is installed on the lance head (4), being offset radially outwards with regard to the at least one oxidator outlet orifice (8).

28. The lance as claimed in claim 20, wherein the annular fuel passage (23) coaxially encloses the holding cylinder (15).

29. The lance as claimed in claim 1, wherein the at least one fuel nozzle (6) is configured to inject the fuel into the mixing path (2) obliquely to at least one of: an axial direction of the lance (3) or a central longitudinal plane of the lance (3).
